(19) United States
(12) Patent Application Publication
(10) Pub. No.: US 2021/0262582 A1
(43) Pub. Date: Aug. 26, 2021

(54) PNEUMATIC VALVE POSITIONER WITH FEEDBACK CONTROLLED FLOW BOOSTER

(71) Applicant: Flowserve Management Company, Irving, TX (US)

(72) Inventors: Michael P. Yost, Santaquin, UT (US); Michael P. Nelson, Lehi, UT (US); Douglas G. Forman, Provo, UT (US); Bradford B. Haines, Spanish Fork, UT (US); Mitchell L. Price, Springville, UT (US); Darin Kent Woolf, Springville, UT (US); Kenneth L. Beatty, Spanish Fork, UT (US)

(73) Assignee: Flowserve Management Company, Irving, TX (US)

(21) Appl. No.: 16/796,510

(22) Filed: Feb. 20, 2020

(51) Int. Cl. F16K 31/122; F15B 13/02; F16K 37/00; F15B 11/046

(52) U.S. Cl. CPC F16K 31/1221; F15B 13/024; F15B 2013/0409; F15B 11/046; F16K 37/0041

(57) ABSTRACT

A pneumatically controlled flow booster includes a booster valve plug position sensor that enables control of the flow booster in a feedback loop, for example by a pneumatic valve positioner, thereby providing accurate, high speed, high flow control of both small and large actuator adjustments. Embodiments can accurately control a surge suppression valve over extended valve adjustment ranges and can fully open a surge suppression valve during a trip. The flow booster valve can include a spool and sleeve valve and/or a poppet valve. Embodiments provide bimodal flow boosting, whereby the output flow is less dependent on the valve plug position in a first position range, and more strongly dependent on the valve plug position in a second range.

### FIELD OF THE INVENTION

The invention relates to valve control systems, and more particularly, to pneumatic valve positioners that provide rapid, accurate control of valve actuators over both small and large adjustment intervals.

### BACKGROUND OF THE INVENTION

The operation of a control valve involves positioning a plug relative to a stationary seat within the valve, whereby an actuator that is directly coupled to the valve plug via a stem is used to move the valve plug to a desired control position. The action of the valve stem can be either linear or rotary, depending on whether the valve is a liner or rotary valve.

With reference to FIG. 1A, sometimes a system controller 100 can directly regulate a valve “actuator” 108 that controls the valve stem of a “process” valve 102 within a system or process 104 by using a sensor 106 to monitor a flow rate through the process valve 102, and/or other process parameters, and by directly controlling the valve actuator 108, for example via an electrical signal to a solenoid valve actuator 108, until the desired process parameters are achieved. However, there can be significant delays between valve adjustments and measured system responses, according to the physical characteristics of the system in which the valve is implemented, thereby restricting the ability of this approach to respond rapidly to system requirements. As modern systems have continued to demand higher efficiencies, the need has increased for improved control valve performance, often demanding fast response and accuracies within 0.5% of set point.

With reference to FIG. 1B, one approach is to implement a “valve positioner” 110 as part of the valve control system. As the term is used herein, a valve positioner 110 is a device that accurately and rapidly adjusts or “positions” a valve actuator 108 to a required linear or rotary position by applying a mechanical, electrical, or pneumatic signal or force to the valve actuator 108 until the physical position of the valve actuator 108, as measured by a valve position sensor 112, reaches the required value. The required position can be specified as a valve position requirement that is communicated by an electrical, mechanical, or pneumatic control signal 113 applied to the valve positioner 110. For example, a system controller 100 can issue a valve position requirement to the valve positioner 110 based on a relationship table that correlates valve actuator positions to process fluid flow rates. Subsequently, if there are any changes to the position of the valve actuator 108, due for example to changes in process fluid pressure, the changes will be immediately sensed by the valve actuator position sensor 112 and relayed to the valve positioner 110, whereupon the valve positioner 110 will compensate by adjusting the applied mechanical, electrical, or pneumatic signal or force until the valve actuator 108 is returned to the required position.

It is often desirable to implement pneumatic gas control of a process valve 102, for example to simplify the system design, reduce cost, and improve resistance to harsh environmental conditions. In the example of FIG. 1B, the valve positioner 110 is pneumatic, and has a gas inlet 114 that is connected to a supply 152 of pressurized air or another control gas such as nitrogen.

In the example of FIG. 1B, a single air pneumatic output 116 of the valve positioner 110 is directed to a piston-driven valve actuator 108 that includes a return spring 118, such that application of pneumatic pressure 116 drives the piston 120 into the spring 118, while venting of the pneumatic pressure 122 allows the return spring 118 to drive the piston 120 in the opposite direction. With reference to FIG. 1C, in other cases a piston-driven valve actuator 108 can be pressure driven in both directions, and the valve positioner 110 can provide two pneumatic outputs 116, 124 directed to the two sides of the piston 120. In the examples of FIGS. 1B and 1C the feedback to the valve positioner 110 from the actuator sensor 112 is mechanical, whereby movement of the piston 120 within the valve actuator 108 mechanically rotates a feedback shaft 126 of the valve positioner 110. Note that while the mechanical feedback is indicated in FIGS. 1B and 1C by dashed lines, the physical details of the mechanical feedback are not accurately represented, and are omitted in some of the subsequent drawings for simplicity of illustration.

It should be understood that, for simplicity of expression, reference is sometimes made herein to “air” as the pneumatic gas that is used to control the process valve actuator 108. In the industry, this is sometimes referred to as “instrument air.” However, the term “air” is used herein to refer to any pneumatic control gas, such as nitrogen gas for example, unless otherwise required by context.

It is notable that a valve positioner 110 implements at least one feedback “loop,” in that the mechanical, electrical or pneumatic signal or force that is applied to the valve actuator by the valve positioner 110 is regulated and controlled by the valve positioner 110 according to feedback provided to the valve positioner 110 by the valve position sensor 112. Some valve positioners implement a plurality of feedback loops. For example, with reference to FIG. 1D, the Logix 3800 pneumatic valve positioner 110, manufactured by the present applicant, implements an “inner” control loop 128 and an “outer” control loop 130. The inner loop 128 controls a pair of poppet valves 132 that determine the air pressure that is presented at either or both of two pneumatic outputs 116, 124 of the Logix 3800 110. In particular, the inner loop 128 accepts an electrical command 138 from the outer loop 130 to set one or both of the poppet valves 132 to desired positions, and executes the command by energizing solenoids that control the poppet valves 132. The inner loop adjusts the energy applied to the solenoids according to feedback signals 134 received from sensors 154 that measure the stem positions of the poppet valves 132. Accordingly, the inner loop 128 functions, in essence, as an internal valve positioner that controls the positions of the poppet valves 132, which results in changes to the air pressures that are presented at the pneumatic outputs 116, 124 of the Logix 3800 110.

The outer loop 130 of the Logix 3800 110 accepts electronic valve position requirement commands 113 from a system controller 100. The outer loop 130 executes these commands by sending commands 138 to the inner loop 128 to adjust the poppet valves 132 according to a pre-calibrated relationship table. The outer loop uses feedback 136 received from a process valve position sensor 112 to monitor the resulting changes to the process valve actuator position, and to determine if any adjustments should be made by sending further commands to the inner loop 128. The Logix 3800 110 is able to accept process valve actuator position feedback 136 either via a “feedback shaft” 126 that provides a direct mechanical link 112 to the valve actuator 108, or via electronic signals received from a remote sensor 112 that can be coupled to the process valve actuator 108.

When implementing a pneumatic gas valve positioner 110 such as the Logix 3800 to control a process valve 102 in a system, at least three factors or aspects can be critical to the speed and accuracy with which the process valve can be controlled. One aspect is the physical size and pneumatic capacity of the valve actuator 108, which typically corresponds to the size and capacity of the process valve itself 102. A physically large pneumatic gas actuator 108 that is able to apply strong actuating forces to a large capacity process valve 102 will typically require input or removal of a large volume of pneumatic air so as to change the pneumatic pressure, and thereby change the position of the actuator 108.

A second factor that can be critical to the speed and accuracy of process valve control is the required speed with which changes to the actuator position must be made. For a given actuator size or pneumatic volume, faster changes will require higher pneumatic flow rates.

A third factor that can be critical to the speed and accuracy of process valve control is the maximum change in actuator position that will be required in a single adjustment. Large changes will require more time and/or more air flow, and will also have a greater tendency to “overshoot” desired actuator positions, making it more difficult to provide accurate control.

One example of a type of valve implementation that can be highly challenging to accurately control is a surge suppression valve implemented in combination with a large centrifugal or axial dynamic gas compressor, as are often used, for example, in the petrochemical industry. In many cases, such compressors are designed to operate at between 50% and 100% of their rated capacity. When the flow rate drops below 50% of capacity, for example due to failure of a seal or an inlet pipe, such compressors can experience a condition known as a “surge.” When this occurs, the compressor impellers are not able to achieve sufficient “head” to maintain the output pressure above the downstream pressure. As a result, due to the open vane construction used in such compressors, the process gas momentarily reverses its direction of flow through the compressor. The surge is a transient event, in that the compressor reengages and restores flow once the excess discharge pressure is relieved and fluid is once again present at the compressor inlet. However, so long as the underlying cause is not eliminated, such surges will tend to repeat in a cycle, typically every 0.5 to 3 seconds, which can severely damage the compressor before it can be shut down.

For this reason, with reference to FIG. 1E, many systems 104 of this type implement a surge suppression valve 102 that can be opened to allow fluid to flow from the compressor discharge 140 back to the compressor inlet 142, thereby ensuring that sufficient fluid is available at the inlet 142 to avoid a surge. In the simplest case, as illustrated in FIG. 1E, the surge suppression valve 102 is closed during normal operation, and is only opened when a “trip” condition is sensed by a flow or pressure sensor 106, at which point the surge suppression valve 102 is opened as fully and rapidly as possible. Surge suppression valves 102 that are controlled by a pneumatic gas such as air therefore require a very high pneumatic control flow when a trip condition occurs, so that the surge suppression valve 102 can be opened as rapidly as possible.

In cases where a compressor is normally operated near its maximum flow rate, it can be sufficient to provide a surge suppression valve that reacts only when a trip condition occurs, for example due to a broken seal or pipe. However, in some implementations it can be desirable to operate a compressor under conditions where the back-pressure is high, such that the flow rate through the compressor is near its minimum rated flow, i.e. just above the rate where a surge might occur. As a result, there is a danger that a surge may occur simply due to a transient fluctuation in the inlet fluid supply, due to thermal conditions, or due to other relatively benign causes. While a surge suppression valve might prevent physical damage to the compressor in such cases, nevertheless there can be a very high cost associated with the “down time” that results from a shutdown and re-start of the compressor, which can result in hours and even days of lost productivity.

In such cases it can be desirable to cause the surge suppression valve to allow a small amount of process fluid to “reverse” flow from the discharge to the inlet even during normal operation, and to regulate this reverse flow by making small, rapid changes that compensate for any fluctuations in the pressure or flow of the input process fluid, especially when such fluctuations might otherwise lead to a trip condition. Because of the speed with which a surge can develop, it is necessary for these small reverse flow adjustments to be made very quickly. And because the system is being operated under near-surge conditions, it is necessary for the surge suppression valve 102 to be controlled accurately, i.e. with minimum overshoot. Furthermore, it is necessary that the valve control system maintain the ability to open the surge suppression valve fully and rapidly in the case of a trip condition, so that the compressor is protected from surge damage until it can be shut down.

Accordingly, in such cases the surge suppression valve control system must be able to operate in two very different modes, whereby during normal operation it attempts to prevents surges by making small, highly accurate adjustments to the reverse flow, while during a trip condition it protects the compressor from damage by making a very large, very rapid change, i.e. by fully opening the surge suppression valve as rapidly as possible. It can be highly challenging for a valve control system to meet all of these requirements.

With reference to FIG. 1F, one approach is to include lock-up valves 144, 146 controlled by a switching valve 160 that enable the valve positioner 110 to regulate the position of the valve actuator 108 during normal operation, but bypass the valve positioner 110 and rapidly drive the valve actuator 108 to one of its extremes in case of a trip by venting one side 144 of the valve actuator 108 while applying 146 a large volume of air from a pre-pressurized volume tank 162 to the other side of the valve actuator 108.

With reference to FIG. 1G, a more powerful approach is to implement a plurality of pneumatic flow boosters 148 in series with the outputs of a pneumatic valve positioner 110, so that the outputs of the valve positioner 110 are directed to the flow boosters, and the outputs of the flow boosters 148 are directed to the valve positioner 108. The flow boosters 148 are activated whenever their pneumatic output pressures differ from their pneumatic input pressures by more than a specified threshold pressure difference.

Typically, the flow boosters 148 are configured such that when the pressure of the pneumatic control input air applied by the valve positioner 110 varies by a small amount, i.e. less than the specified threshold pressure difference, air is allowed to bleed through the flow booster 148 directly from the valve controller 110 to the valve actuator 108 until the two pressures are equalized. Accordingly, smaller changes to the reverse process flow that are made during normal operation are directly and accurately controlled by the valve positioner 110, i.e. without flow boosting. When larger adjustments are required, the flow boosters 148 are activated, thereby extending the range of adjustments that can be made during normal operation.

Of course when a trip condition occurs, the flow boosters 148 ensure that the surge control valve is rapidly and fully opened. To that end, many implementations direct each of the outputs of the valve positioner to a plurality of flow boosters operating in parallel, so as to ensure that sufficient flow is available during a trip. Typically, “lock-up” valves 144, 146 are also included that can be activated to rapidly vent one side 144 of a piston or diaphragm valve positioner 108 so that it can be rapidly opened, while flooding the other side 146 of the valve actuator 108 with pressurized air from a volume tank 162.

The approach of FIG. 1G can be effective. However, successful operation is highly dependent on accurate setting and adjustment of the pressure thresholds at which the flow boosters 148 are activated. In particular, the performance of the valve control system can be significantly degraded if the pressure thresholds of all of the flow boosters 148 are not set precisely equal to each other, especially when a plurality of flow boosters 148 are operating in parallel. Any misadjustments or miss-calibration of the flow boosters 148 can lead to inconsistent flow booster activation, whereby performance of the system can degrade or become unstable. Furthermore, feedback delays are introduced by the flow booster(s) 148, which can lead to overshoot and other problems with speed and precision when large, rapid adjustments of the surge suppression valve 102 are required during normal operation so as to avoid a trip event.

Another approach is to avoid the use of flow boosters 148, and instead to use a high output flow, high speed, high accuracy valve positioner to directly control the surge suppression valve, where high flow and speed is realized by implementing large stepper motor controlled valves in the valve positioner. However, this approach is complex and costly, and can also be highly difficult to adjust and tune for proper operation.

What is needed, therefore, is an apparatus and method for pneumatically controlling the position of a valve actuator that can provide accurate, high speed, high flow control of both small and large actuator adjustments, while also being simple and reliable in design and easy to tune and adapt for control of a valve system.

### SUMMARY OF THE INVENTION

The present invention is an apparatus and method for pneumatically controlling the position of a valve actuator. The disclosed apparatus and method can provide rapid, accurate, high speed, high flow control for both small and large actuator adjustments, while also being simple and reliable in design and easy to tune and adapt for control of a valve system. The disclosed apparatus is a novel flow booster, referred to herein as a “JetFlow” booster, which is controlled by the output of a pneumatic valve positioner.

The JetFlow booster further includes a booster valve plug sensor that provides feedback to the valve positioner indicating the physical position of the booster valve plug within the booster valve. The valve positioner is thereby able to implement an additional feedback loop that controls the booster valve plug position within the JetFlow booster, such that the JetFlow booster acts as a feedback-controlled extension of the valve positioner. As a result, the valve positioner and JetFlow booster, in combination, function as a high flow capacity valve positioner that can rapidly and accurately implement both small and large valve adjustments with little or no overshoot, and without requiring complex electronics such as stepper motors.

According to the present design there is no need to bleed valve positioner output through the JetFlow booster, and hence there is no need to set, adjust, or calibrate any threshold pressure differences, in contrast to the approach of FIG. 1G. The JetFlow booster is therefore more reliable and stable, and simpler to implement than previous solutions. Embodiments that control surge suppression valves are able to compensate for larger fluctuations in process input fluid flow as compared to previous approaches, thereby providing a more effective mechanism for preventing surge trip conditions.

In embodiments, the JetFlow booster valve is bi-modal, in that the flow through the booster valve is divided into two ranges of booster valve plug position. Within the first range of valve plug positions, the gas flow through the JetFlow booster valve changes gradually as the position of the booster valve plug is varied. This range of operation is suitable for making relatively fine adjustments to a process valve actuator. Over the second range of valve plug positions, the gas flow through the JetFlow booster valve changes more rapidly as a function of the position of the booster valve plug. This range of operation is suitable for making relatively larger adjustments to the process valve actuator. Embodiments implement more than two valve plug position ranges that have distinct relationships between changes in output pressure/flow rate and changes in booster valve plug position.

In some embodiments, the JetFlow booster has sufficient flow capacity to fully and rapidly open a surge suppression valve during a surge trip event. Various method embodiments further implement a lock-up valve that vents at least one of the pneumatic inputs to the valve actuator in the event of a surge trip.

In embodiments, the JetFlow booster valve plug position sensor is mechanical or magnetic, and provides either mechanical or electronic feedback to the valve positioner. In embodiments, the JetFlow booster valve is a spool and sleeve valve or a poppet valve.

In embodiments, all interactions between the the JetFlow booster valve and the associated valve positioner are pneumatic and/or mechanical, such that the JetFlow booster valve does not require an independent power source, and is thereby an intrinsically nonincendive, explosion proof, and/or safety compliant system, for example per the NFPA and NEC or equivalent internal standards. In some embodiments, the valve positioner is powered by a control signal such as a 4-20 mA signal, and does not require a separate power supply, which simplifies compliance with incendive, explosion, and safety compliant standards.

One general aspect of the present invention is a flow booster valve that includes a first pneumatic control inlet configured to receive a first pneumatic control gas having a first pneumatic control pressure, a booster valve plug having a variable position within the flow booster valve, wherein a first longitudinal force is applied to the booster valve plug that is proportional to the first pneumatic control pressure, a first flow inlet in gas communication with a first flow outlet, a first gas flow from the first flow inlet to the first flow outlet being variable according to the position of the booster valve plug within the flow booster valve, and a valve plug position sensor configured to provide a sensor output that is indicative of the position of the booster valve plug within the booster valve.

In embodiments, a plug range over which the position of the booster valve plug is variable within the flow booster valve comprises a first position subrange and a second position subrange, and wherein the first primary gas flow is more strongly dependent on the position of the booster valve plug when the booster valve plug is within the second position subrange as compared to when the booster valve plug is within the first position subrange. In some of these embodiments, the first primary gas flow is variable according to a non-linear dependence on the position of the booster valve plug when the booster valve plug is in the first position subrange.

In any of the above embodiments, the flow booster valve can be configured such that it does not include any electrically operated components

In any of the above embodiments, the sensor output of the valve plug position sensor can be mechanical.

In any of the above embodiments, the sensor output of the valve plug position sensor can be one of electrical and pneumatic.

In any of the above embodiments, the flow booster valve can further include a valve plug return spring configured to apply a return force to the booster valve plug in opposition to the first longitudinal force.

In any of the above embodiments, the flow booster valve can further include second pneumatic control inlet configured to receive input of a second pneumatic control gas having a second pneumatic control pressure, a second longitudinal force that is proportional to the second pneumatic control pressure being applied to the booster valve plug, the second longitudinal force being in opposition to the first longitudinal force.

In any of the above embodiments, the flow booster valve can include a second flow inlet in gas communication with a second flow outlet, a second gas flow from the second flow inlet to the second flow outlet being variable according to the position of the booster valve plug within the flow booster valve. In some of these embodiments a dependence of the first gas flow on the position of the booster valve plug and a dependence of the second gas flow on the position of the booster valve plug are substantially equal and opposite.

In any of the above embodiments, the flow booster valve can include a spool and sleeve valve.

In any of the above embodiments, the flow booster valve can include a poppet valve.

Any of the above embodiments can further include a gas vent, wherein when the booster valve plug is in a first position the gas vent is in gas communication with the first flow outlet while the first flow inlet is blocked, and when the booster valve plug is in a second position the gas vent is blocked while the first flow inlet is in gas communication with the first flow outlet.

Any of the above embodiments can further include a valve position controller configured to receive the sensor output provided by the valve plug position sensor, the valve position controller being further configured to supply the first pneumatic control gas to the first pneumatic control input. And in some of these embodiments the flow booster valve further comprises a supply gas outlet in gas communication with a gas supply inlet of the valve position controller.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a block diagram illustrating direct control of a process valve by a system controller according to the prior art;

FIG. 1B is a block diagram illustrating one-way pneumatic control of a process valve by a valve positioner according to the prior art;

FIG. 1C is a block diagram illustrating two-way pneumatic control of a process valve by a valve positioner according to the prior art;

FIG. 1D is a block diagram of a valve positioner that implements both inner and outer feedback loops according to the prior art;

FIG. 1E is a block diagram illustrating direct control of a surge suppression valve by a system controller according to the prior art;

FIG. 1F is a block diagram illustrating control of a surge suppression valve by a valve positioner according to the prior art;

FIG. 1G is a block diagram illustrating control of a surge suppression valve by a valve positioner and flow boosters according to the prior art;

FIG. 2A is a cross sectional illustration of a JetFlow booster valve according to an embodiment of the present invention;

FIG. 2B is a block diagram illustrating implementation of the JetFlow booster of FIG. 2A to control a surge suppression valve;

FIG. 3 is a block diagram that illustrates three control loops that are implemented by a Logix 3800 valve positioner in combination with a JetFlow booster in an embodiment of the present invention;

FIG. 4A is a graph of a bimodal output flow dependence upon JetFlow valve plug position in an embodiment of the present invention;

FIG. 4B is a cross sectional illustration similar to FIG. 2A of a JetFlow booster valve of the present invention that is configured to provide bimodal output flow as illustrated in FIG. 4A;

FIG. 5A is an isometric view, drawn to scale, of a spool and sleeve JetFlow booster embodiment of the of the present invention coupled to a Logix 3800 valve positioner;

FIG. 5B is a partially exploded perspective view from below, drawn to scale, of the valve positioner and JetFlow booster of FIG. 5A;

FIG. 5C is a top view, drawn to scale, of a disassembled spool and sleeve sleeve of the JetFlow booster of FIG. 5B

FIG. 6A is an isometric view drawn to scale of a poppet valve JetFlow booster embodiment of the present invention coupled to a Logix 3800 valve positioner;

FIG. 6B is a left side view drawn to scale of the JetFlow booster and Logix 3800 valve positioner of FIG. 6A;

FIG. 6C is an interior perspective view drawn to scale of the JetFlow booster of FIGS. 6A and 6B, wherein the sleeve elements and the control air element of the JetFlow booster have been removed to reveal a central shaft thereof, three of the sleeve elements and the control air element being separately illustrated with inner structure thereof indicated by dashed lines;

FIG. 6D is a perspective view drawn to scale of the central shaft of the embodiment of FIG. 6C separated from the support frame so that the sensor arm thereof is visible; and

FIG. 6E is a perspective view drawn to scale of the embodiment of FIG. 6A, where that the Logix 3800 has been lifted above the JetFlow booster so that a sensor interconnection therebetween is visible.

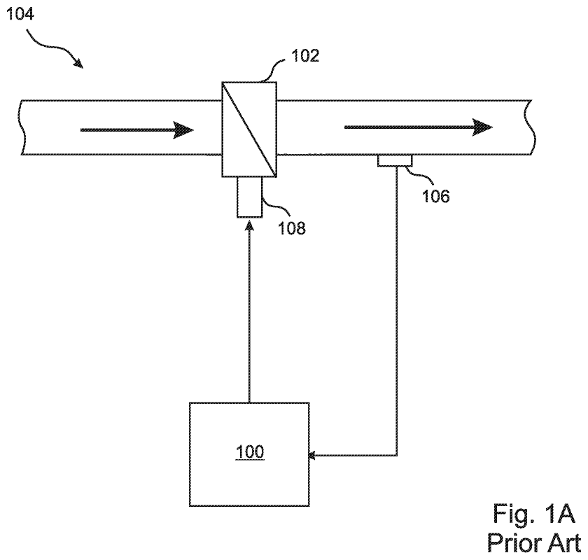

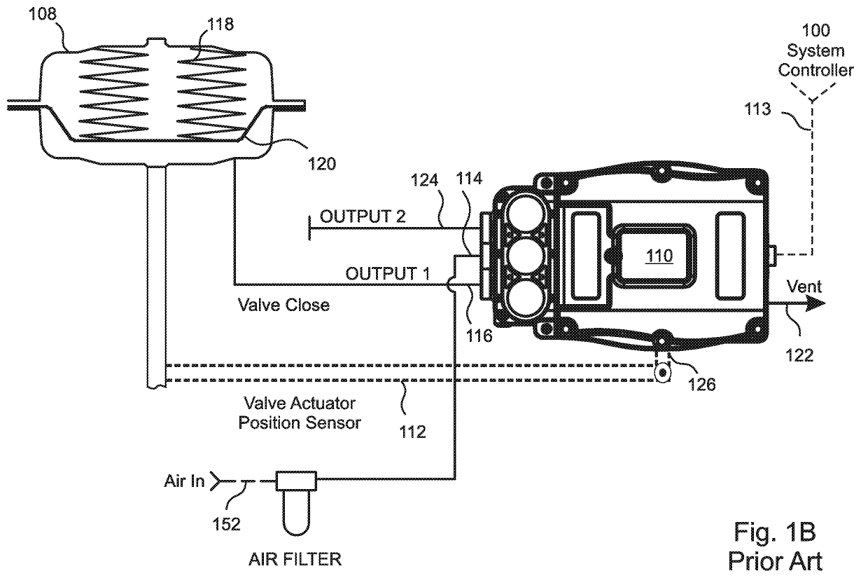

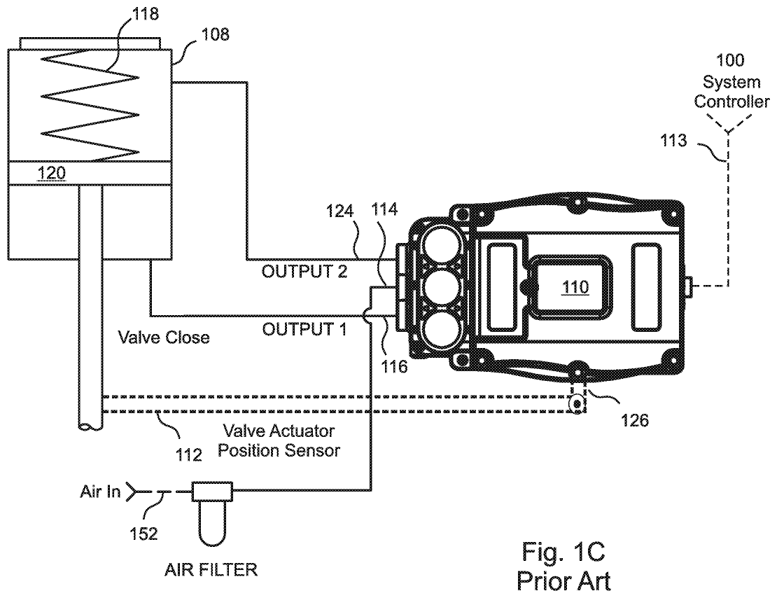

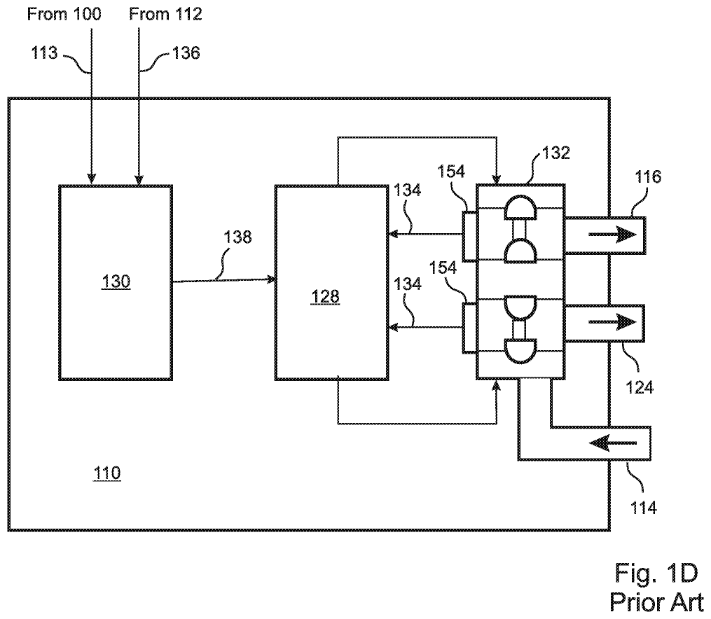

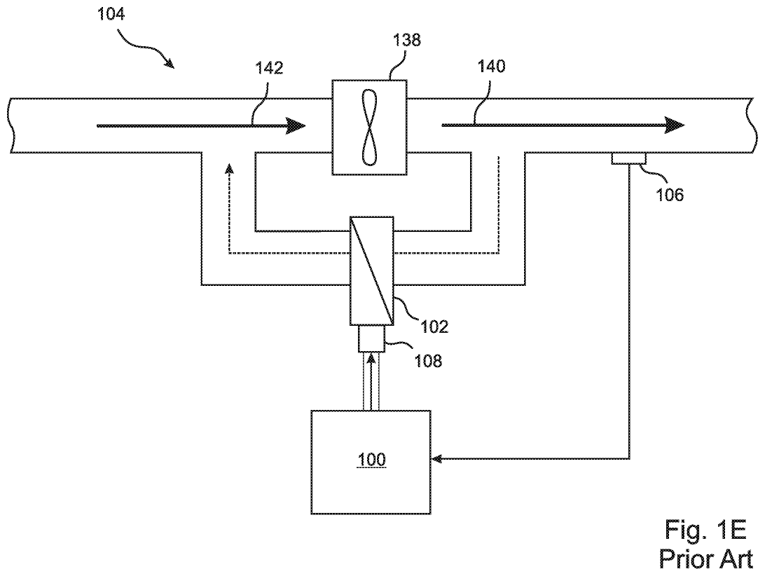

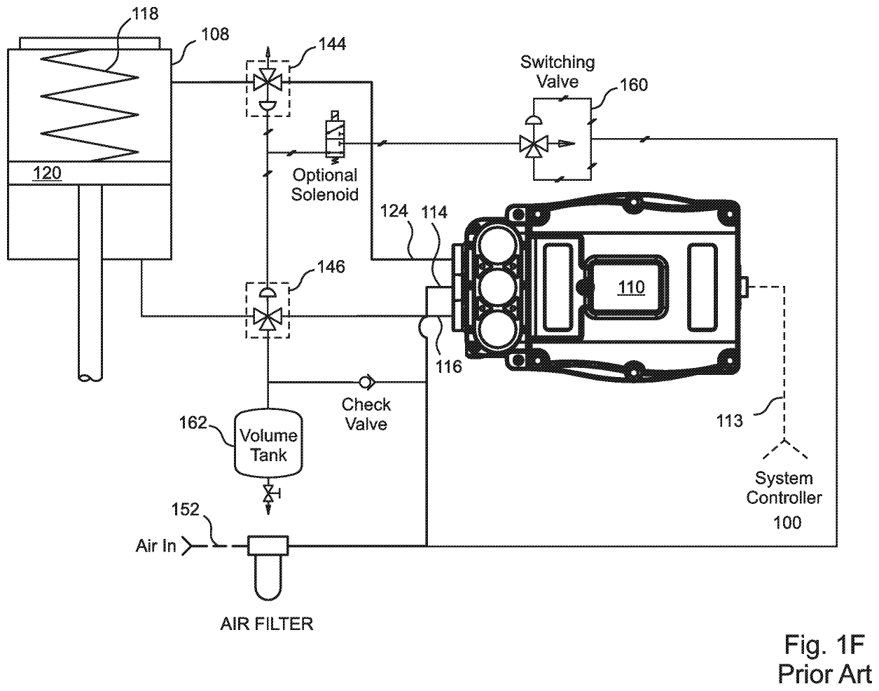

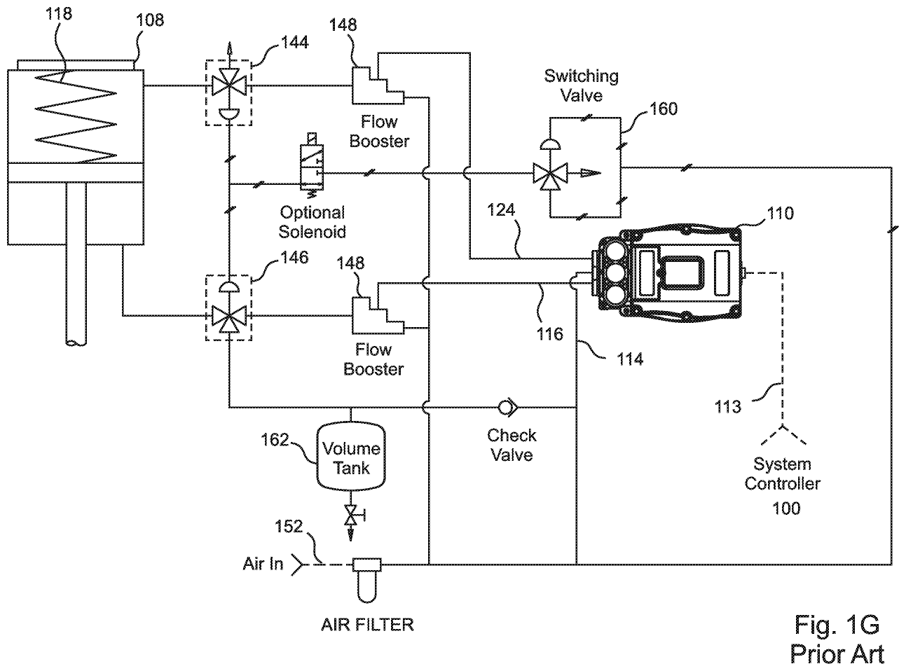

### DETAILED DESCRIPTION

The present invention is an apparatus and method for pneumatically controlling the position of a valve actuator. The disclosed apparatus and method can provide rapid, accurate, high speed control for both small and large actuator adjustments, while also being simple and reliable in design and easy to tune and adapt for control of a valve system.

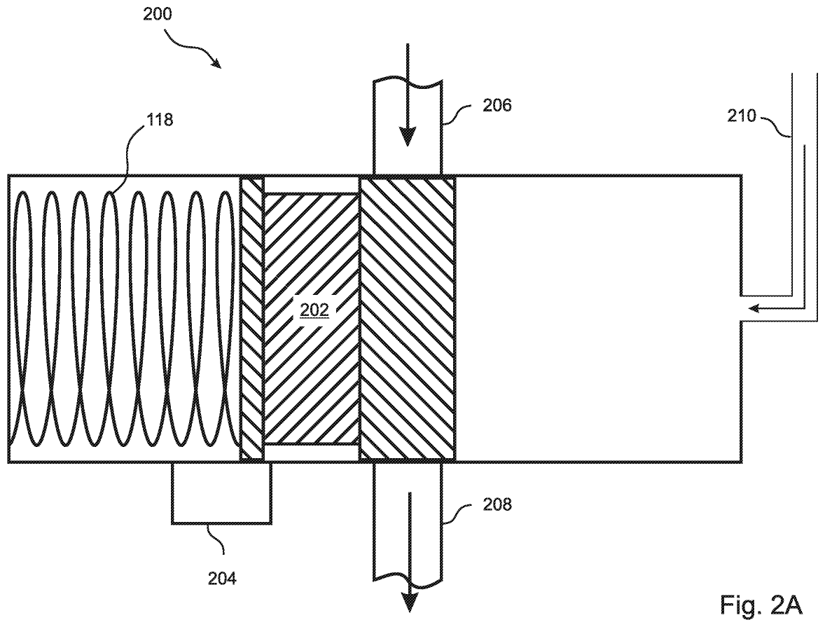

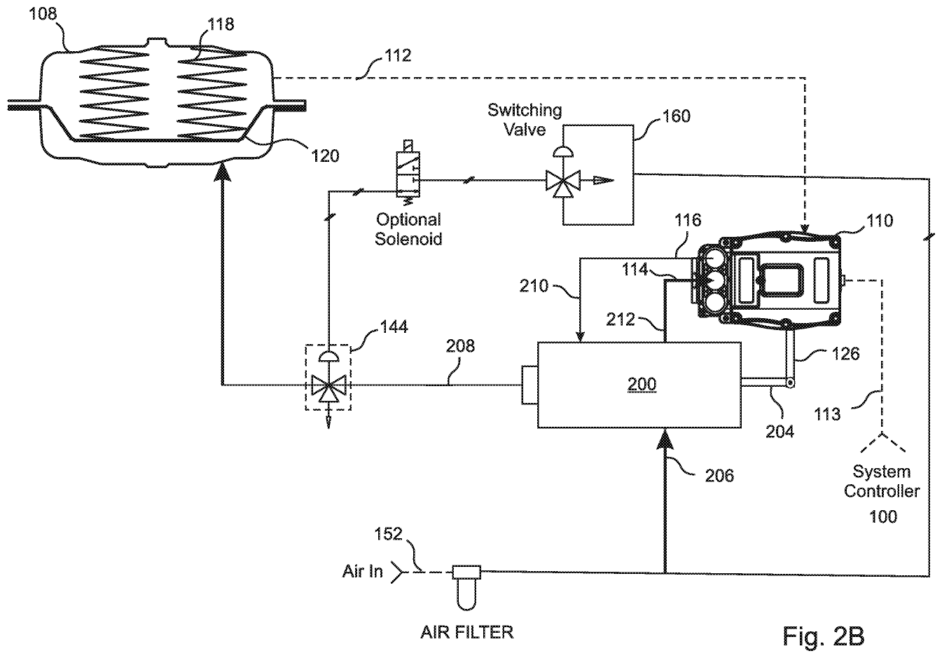

With reference to FIGS. 2A and 2B, the disclosed invention is a novel flow booster 200, referred to herein as a “JefFlow” booster, in which a booster valve plug 202 can be controlled by the gas output of a pneumatic valve positioner 110 such as a Logix 3800. The JetFlow booster valve 200 accepts a relatively high flow pneumatic input 206, and is able to provide a high flow output 208 that is proportional in pressure and flow to a relatively small pneumatic control input 210 supplied by the valve positioner 110. In the embodiment of FIG. 2B, the JetFlow booster valve 200 further includes an air supply output 212 that provides input air 114 for the valve positioner 110.

The JetFlow booster valve 200 of the present invention further includes a booster valve plug sensor 204 that can provide feedback to the valve positioner 110 indicating the physical position of the booster valve plug 202 within the JetFlow booster valve 200. In the illustrated embodiment, the booster valve plug sensor 204 is a mechanical sensor that links with the feedback shaft 126 of the Logix 3800 valve controller. The valve positioner 110 is thereby able to implement an additional feedback loop that controls the positioning of the booster valve plug 202 within the JetFlow booster valve 200, such that the JetFlow booster valve 200 acts as a feedback-controlled extension of the valve positioner 110. As a result, the valve positioner 110 and JetFlow booster valve 200, in combination, function as a high flow capacity valve positioner that can accurately implement rapid valve adjustments with both small and large adjustment amplitudes with little or no overshoot, and without requiring complex electronics such as stepper motors. In consequence, the disclosed apparatus is more reliable and simpler to tune than previous solutions. Embodiments implemented to control surge suppression valves are able to compensate for larger fluctuations in process flow as compared to previous approaches, thereby providing a more effective mechanism for preventing surge trip conditions.

In embodiments, all interactions between the the JetFlow booster valve 200 and the associated valve positioner 110 are pneumatic and/or mechanical, such that the JetFlow booster 200 valve does not require an independent power source, and is thereby an intrinsically nonincendive, explosion proof, and/or safety compliant system, for example per the NFPA and NEC or equivalent internal standards. In some embodiments, the valve positioner 110 is powered by a control signal such as a 4-20 mA signal, and does not require a separate power supply, which simplifies compliance with incendive, explosion, and safety compliant standards.

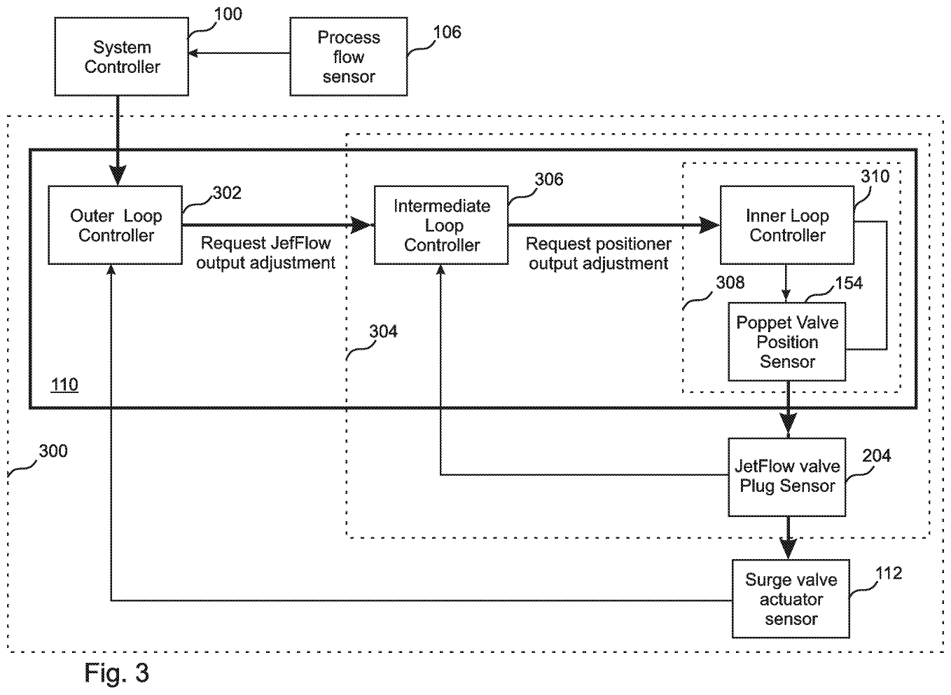

As an example, with reference to FIG. 3, the disclosed JetFlow booster can be controlled by a Logix 3800 valve positioner 110 whereby the JetFlow booster is implemented in a third, nested, “intermediate” control loop 304. In exemplary embodiments, the outer loop 300 of the Logix 3800 includes an outer loop controller 302 that receives a required valve position command from a system controller 100 to adjust the valve actuator 108 of a surge suppression valve 102 to a required actuator position. The outer loop controller 302 consults a calibrated relationship table and converts this request into a required change to the position of the JetFlow booster valve plug 202. This requirement is forwarded to the intermediate loop controller 306.

The intermediate loop controller 306 refers to a calibrated relationship table and converts the required position change of the JetFlow booster valve plug 202 into a required position change of the inner loop poppet valve(s) 132. This requirement is forwarded to the inner loop controller 310 for execution by the inner loop 308. Finally, the inner loop controller 310 refers to a calibrated relationship table and converts the required change of the poppet valve(s) 132 into a required change in the electrical energy that is applied to the poppet valve solenoid controller(s).

The inner loop controller 310 then applies the change to the poppet valve controllers, and makes any required corrections according to feedback received from poppet valve position sensors 134. Further commands are sent by the intermediate loop controller 306 to the inner loop controller 310 as needed, according to feedback provided to the intermediate loop controller 306 by the JetFlow valve plug sensor 204. And further commands are sent to the intermediate loop controller 306 by the outer loop controller 302 according to feedback provided to the outer loop controller 302 by the surge valve actuator position sensor 112.

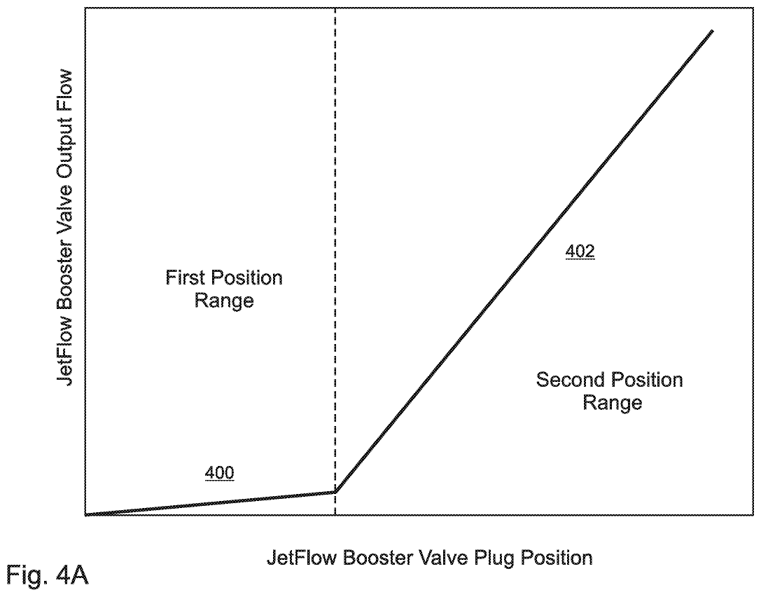

With reference to FIG. 4A, in embodiments the JetFlow booster valve 200 is bi-modal, in that the flow through the booster valve 200 is divided into two position ranges 400, 402 of the booster valve plug 202. Within the first position range 400 of the valve plug 202, the gas flow through the JetFlow booster valve 200 is weakly dependent upon the position of the booster valve plug 202. This range of operation 400 is suitable for making relatively fine adjustments to the process valve actuator 108. Over the second position range 402 of the booster valve plug 202, the gas flow through the JetFlow booster valve 200 is more strongly dependent upon the position of the booster valve plug 202. This range of operation 402 is suitable for making relatively larger adjustments to the process valve actuator 108, and/or for fully opening the process valve 102 during a surge trip. FIG. 4B illustrates a spool and sleeve valve 200 similar to the valve of FIG. 2A, but wherein the JetFlow booster valve plug 202 has two diameter regions 404, 406, corresponding to the two position ranges 400, 402, of FIG. 4A.

In some embodiments the JetFlow booster valve 200 has sufficient flow capacity to fully open the surge suppression valve 100 during a surge trip event. In other embodiments, as illustrated in FIG. 2B, a venting relay system 144, 146 is implemented that blocks the pneumatic output 208 of the JetFlow booster valve 200 and vents the pneumatic input of the surge control valve actuator 108 in the event of a surge trip, thereby allowing the surge control valve actuator spring 118 to open the surge control valve 102 at maximum speed.

In the embodiment of FIG. 2B, the JetFlow booster valve plug position sensor 204 provides mechanical feedback to the valve positioner 110. In similar embodiments, the JetFlow booster valve plug position sensor 204 is magnetic, and provides electronic feedback to the valve positioner 110. In embodiments, the JetFlow booster valve 200 is a spool and sleeve valve or a poppet valve.

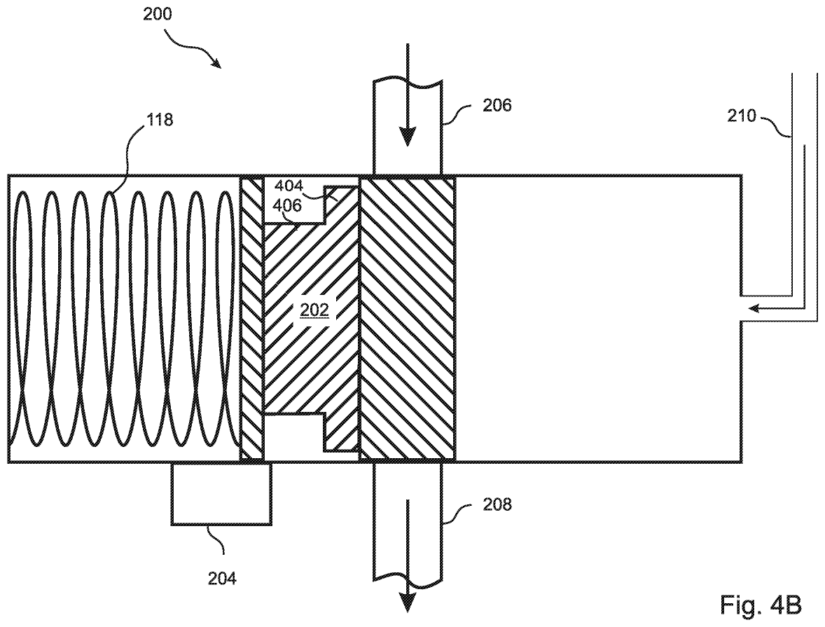

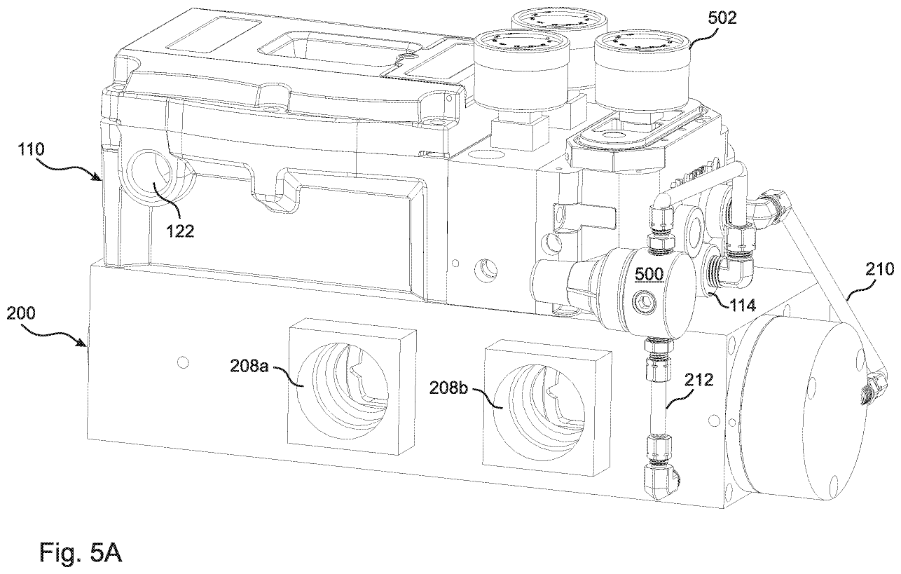

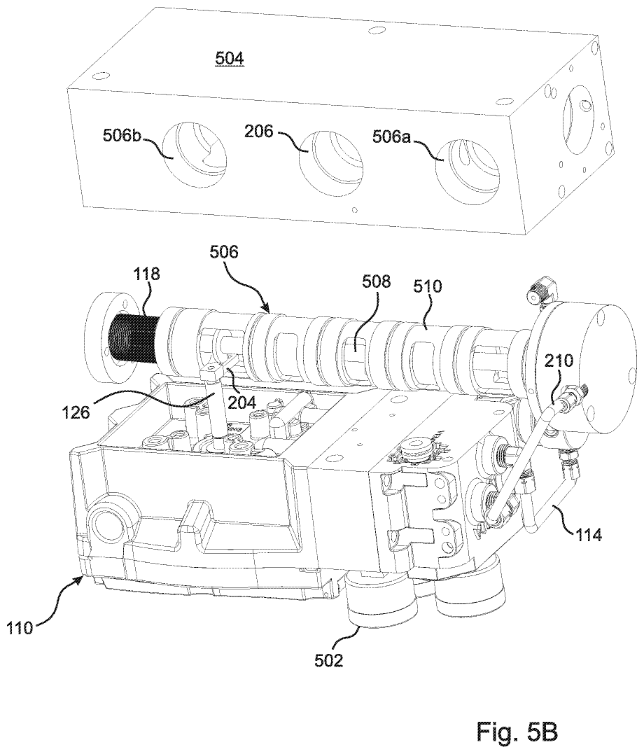

FIG. 5A is a perspective view from above of an embodiment of the present invention in which the JetFlow booster valve 200 is a spool and sleeve valve that is directly mounted to a Logix 3800 valve positioner 110. In the illustrated embodiment, the JetFlow booster valve 200 has two high flow air outlets 208a, 208b. The embodiment further includes an air outlet 212 that is directed through a regulator 500 to provide a lower flow at a regulated pressure to the air inlet 114 of the Logix 3800 110. Also visible in the figure are pressure gages 502 that are included with the Logix 3800 110. Output pneumatic control air from the Logix 3800 110 is directed to a pneumatic control input 210 at a proximal end of the JetFlow booster valve 200.

FIG. 5B is a perspective view from below of the embodiment of FIG. 5A where the sleeve 504 of the JetFlow booster valve 200 has been removed to expose the spool assembly 506 of the valve, which includes a spool 508 and a surrounding spool envelope 510. During operation, the spool envelope 510 remains fixed to the sleeve 504, and the spool 508 moves laterally within the envelope 510. A high flow input, 206 is visible in the figure, as well as two additional ports, 506a, 506b that serve as vent openings of the Jetflow booster valve 200. A spool return spring 118 is also visible at a distal end of the JetFlow booster valve 200. The JetFlow valve plug position “sensor” in the illustrated embodiment is a lever arm 204 having a proximal end fixed to a feedback shaft 126 of the Logix 3800 valve positioner 110, and a distal end coupled to the spool 508 of the JetFlow booster valve 200. As the spool 508 is translated within the spool sleeve envelope 510, the distal end of the lever arm 204 converts the lateral motion of the spool 508 into rotation of the feedback shaft 126 of the Logix 3800, thereby providing feedback to the Logix 3800 as to the position of the JetFlow spool 508. The Logix 3800 110 also receives feedback from the surge suppression valve actuator 108 via electronic signals received from a remote sensor 112 coupled to the surge suppression valve actuator 108.

FIG. 5C is a top view of the embodiment of FIG. 5B in which the spool 508 has been removed from the spool sleeve envelope 510. It can be seen in the figure that the spool 508 includes a pair of cylindrical pistons 202 mounted on a central shaft 512 that function as the valve plugs 202 of the JetFlow booster valve 200. When the JetFlow booster valve 200 is fully assembled, the spool sleeve envelope 510 is fixed to the sleeve 504, and is positioned so that openings 514, 516 provided in the spool sleeve envelope 510 overlap and effectively define the shapes of the high flow inlets 206 and outlets 208 of the booster valve 200. In the illustrated embodiment, these sleeve openings include central, large regions 514 that are substantially rectangular, and that control the relationship between the output flow and the positions of the spool pistons 202 when the spool 508 is in the second position range 402, as discussed above in reference to FIG. 4A. These central regions 514 are flanked by small notch regions 516 that control the relationship between the output flow and the position of the spool 508 when the spool 508 is in the first position range 400. Unlike the linear relationship that is illustrated in FIG. 4A, the “notch” shape of these small opening regions 516 results in a non-linear relationship between spool position and output flow when the spool 508 is in the first position range. Nevertheless, a much lower flow “boost” is provided in the first position range than in the second position region 402.

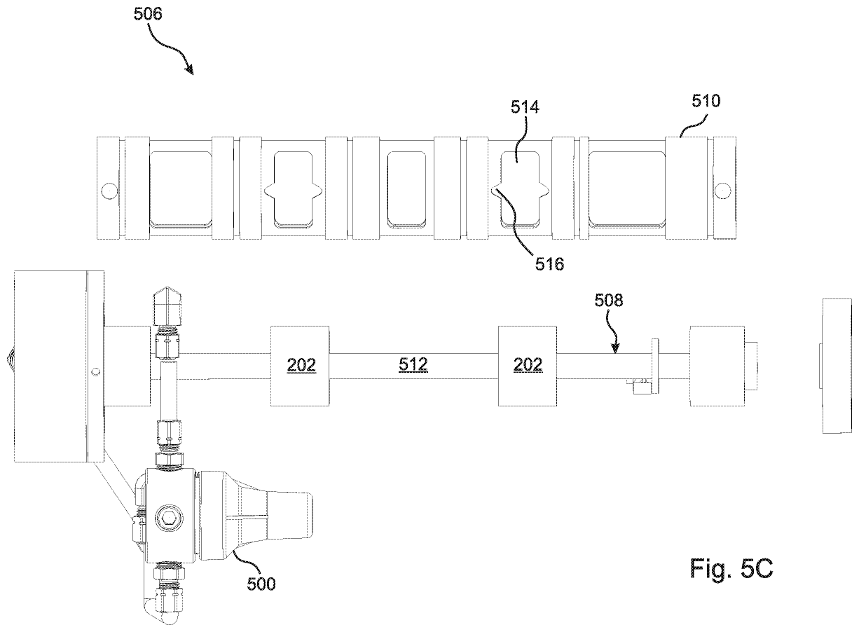

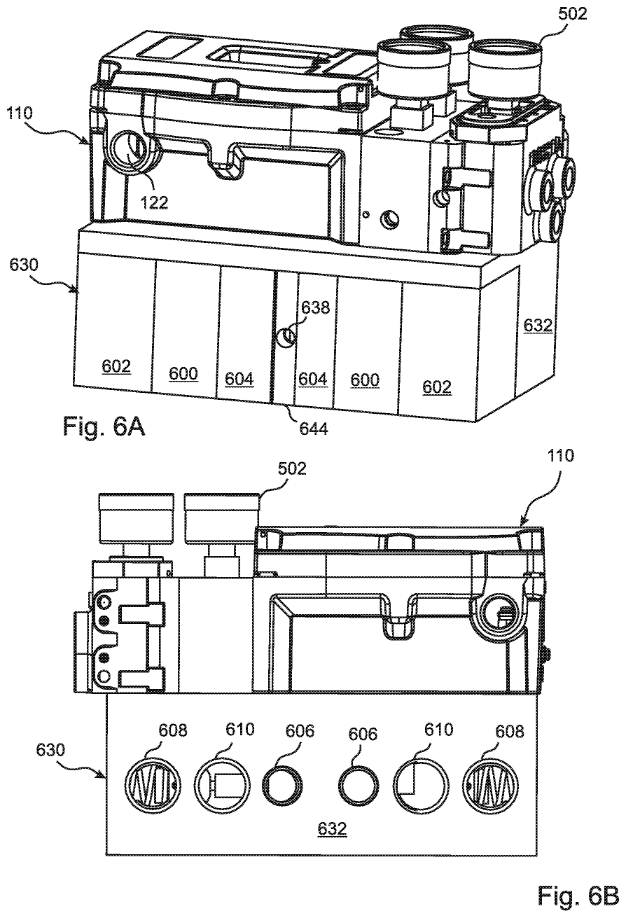

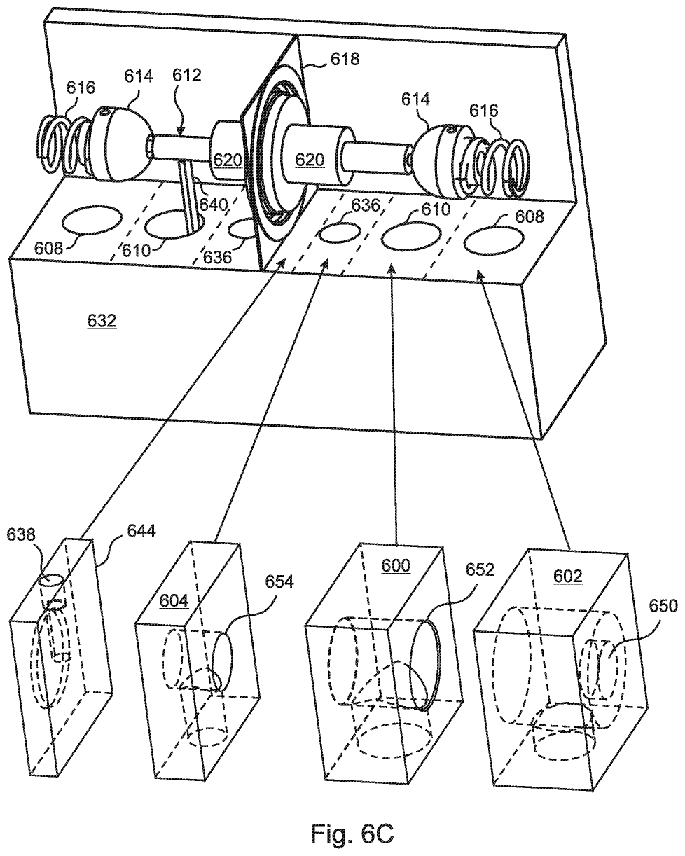

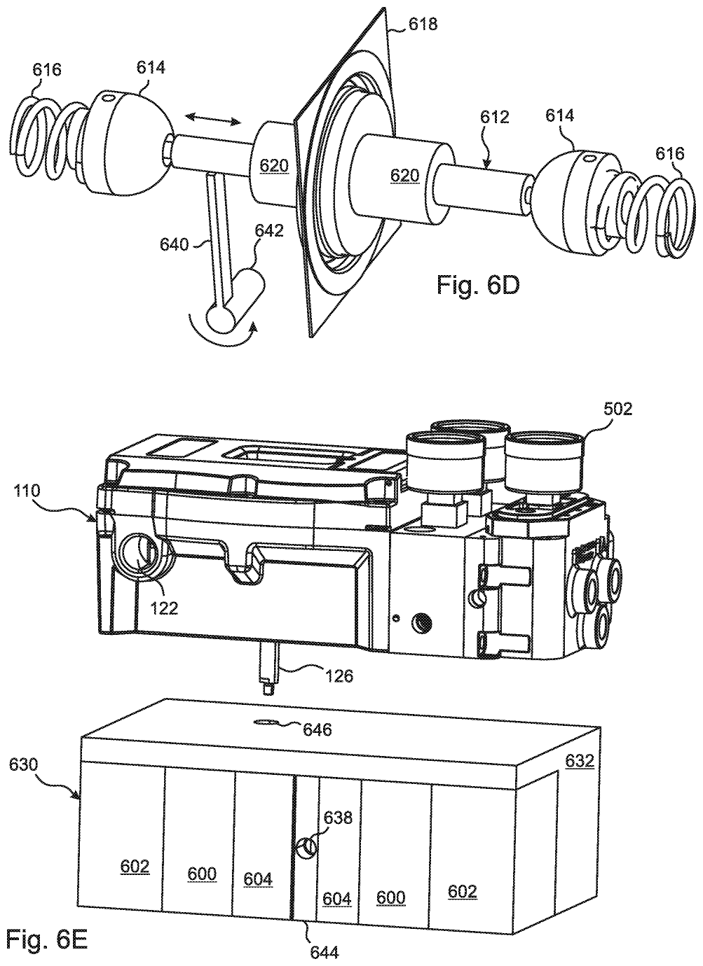

FIG. 6A is a right perspective view of an embodiment in which a Logix 3800 110 is combined with a poppet valve embodiment 630 of the JetFlow booster. In the illustrated embodiment, the poppet JetFlow booster 630 is divided into two substantially symmetric halves, each of which includes a supply sleeve element 600, an end sleeve element 602, and a vent sleeve element 604. In addition, a central control air element 644 is included. All of the sleeve elements 600, 602, 604, 644 are fitted into a common support frame 632.

FIG. 6B is a left side view of the embodiment of FIG. 6A. In the figure, it can be seen that the support frame 632 is penetrated by four large openings, which include two supply inlets 608 and two exhaust outlets 610. In addition, vents 606 are provided that connect with the vent sleeve elements 604. The supply inlets 608 can be connected, for example, to a high-volume gas supply 152, while the exhaust outlets could be connected, for example, to the two opposing gas inlets of a piston-driven valve actuator 108 that is pressure driven in both directions.

FIG. 6C is an interior perspective view of the JetFlow booster 630 of FIGS. 6A and 6B, where the sleeve elements 600, 602, 604, 644 have been removed to reveal a central shaft 612 that is supported by opposing springs 616 at both ends and supported by a central diaphragm 618. The three sleeve elements 600, 602, 604 from the right half of the support frame 632 as well as the control air element 638 are shown separately, with arrows and dashed lines indicating their locations when assembled with the support frame 632. Dashed lines shown within the sleeve elements indicate their internal structure. In particular, the control air input 638 can be seen in the figure on the control air sleeve element 644.

It can be seen in the figure that the springs 616 are supported by coaxial protrusions 650 provided within the end sleeve elements 602, and that the central shaft 612 further includes a pair of opposing poppets 614 and also a pair of vent plugs 620. The poppets 614 nest within poppet seats 652 provided in the supply sleeve elements 600, and the vent plugs 620 nest within central passages 654 of the vent sleeve elements 604, and thereby open and close the vents 636 as the central shaft is laterally shifted by the control air.

Control air applied to the control air inlet 638 of the control air element 644 applies a variable pressure to the diaphragm 618 and causes the central shaft 612 to shift laterally, thereby seating one of the poppets 614 against its poppet seat 652, while separating the other poppet 614 from its seat 652, thereby connecting one supply 610 to its exhaust outlet 608 while isolating the other poppet 614 from its exhaust outlet 608. At the same time, one of the vents 636 is opened while the other is closed.

The central shaft 612 with associated features is shown separated from the support frame 632 in FIG. 6D. It can be seen in the figure that a sensor arm 640 extends from the central shaft 612 in a manner similar to the valve plug sensor 204 of FIG. 5B, discussed above. As can be seen in FIG. 6C, a distal end of the sensor arm 640 is attached to the central shaft 612, and the sensor arm 640 extends from there into one of the exhaust outlets 610, where it terminates in a rotating element 642.

FIG. 6E is similar to FIG. 6A, except that the Logix 3800 110 has been lifted away from the JetFlow booster 630, so that the sensor interconnection between them can be seen. As is visible in the figure, the feedback shaft 126 of the Logix 3800 110 extend into a sensor passage 646 provided in the Jetflow booster 630, which intersects the exhaust outlet 610, so that the feedback shaft 126 can be connected to the rotating element 642 and thereby rotated as the central shaft is longitudinally shifted.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

It will be understood by those of skill in the art that while frequent reference is made herein by way of example to control of a surge suppression valve, the present invention is not limited only to control of surge suppression valves, but is applicable in general to pneumatic gas valve position control where enhanced flow of pneumatic control gas is required.

Although the present application is shown in a limited number of forms, the scope of the invention is not limited to just these forms, but is amenable to various changes and modifications without departing from the spirit thereof. The disclosure presented herein does not explicitly disclose all possible combinations of features that fall within the scope of the invention. The features disclosed herein for the various embodiments can generally be interchanged and combined into any combinations that are not self-contradictory without departing from the scope of the invention. In particular, the limitations presented in dependent claims below can be combined with their corresponding independent claims in any number and in any order without departing from the scope of this disclosure, unless the dependent claims are logically incompatible with each other.

I claim:

1. A flow booster valve comprising:
a first pneumatic control inlet configured to receive a first pneumatic control gas having a first pneumatic control pressure;
a booster valve plug having a variable position within the flow booster valve, wherein a first longitudinal force is applied to the booster valve plug that is proportional to the first pneumatic control pressure;
a first flow inlet in gas communication with a first flow outlet, a first gas flow from the first flow inlet to the first flow outlet being variable according to the position of the booster valve plug within the flow booster valve; and
a valve plug position sensor configured to provide a sensor output that is indicative of the position of the booster valve plug within the booster valve.

2. The flow booster valve of claim 1, wherein a plug range over which the position of the booster valve plug is variable within the flow booster valve comprises a first position subrange and a second position subrange, and wherein the first primary gas flow is more strongly dependent on the position of the booster valve plug when the booster valve plug is within the second position subrange as compared to when the booster valve plug is within the first position subrange.

3. The flow booster valve of claim 2, wherein the first primary gas flow is variable according to a non-linear dependence on the position of the booster valve plug when the booster valve plug is in the first position subrange.

4. The flow booster valve of claim 1, wherein the flow booster valve does not include any electrically operated components.

5. The flow booster valve of claim 1, wherein the sensor output of the valve plug position sensor is mechanical.

6. The flow booster valve of claim 1, wherein the sensor output of the valve plug position sensor is one of electrical and pneumatic.

7. The flow booster valve of claim 1, wherein the flow booster valve further comprises a valve plug return spring configured to apply a return force to the booster valve plug in opposition to the first longitudinal force.

8. The flow booster valve of claim 1, wherein the flow booster valve further comprises a second pneumatic control inlet configured to receive input of a second pneumatic control gas having a second pneumatic control pressure, a second longitudinal force that is proportional to the second pneumatic control pressure being applied to the booster valve plug, the second longitudinal force being in opposition to the first longitudinal force.

9. The flow booster valve of claim 1, wherein the flow booster valve comprises a second flow inlet in gas communication with a second flow outlet, a second gas flow from the second flow inlet to the second flow outlet being variable according to the position of the booster valve plug within the flow booster valve.

10. The flow booster of claim 8, wherein a dependence of the first gas flow on the position of the booster valve plug and a dependence of the second gas flow on the position of the booster valve plug are substantially equal and opposite.

11. The flow booster valve of claim 1, wherein the flow booster valve comprises a spool and sleeve valve.

12. The flow booster valve of claim 1, wherein the flow booster valve comprises a poppet valve.

13. The flow booster valve of claim 1, further comprising a gas vent, wherein when the booster valve plug is in a first position the gas vent is in gas communication with the first flow outlet while the first flow inlet is blocked, and when the booster valve plug is in a second position the gas vent is blocked while the first flow inlet is in gas communication with the first flow outlet.

14. The flow booster valve of claim 1, further comprising a valve position controller configured to receive the sensor output provided by the valve plug position sensor, the valve position controller being further configured to supply the first pneumatic control gas to the first pneumatic control input.

15. The flow booster valve of claim 11, wherein the flow booster valve further comprises a supply gas outlet in gas communication with a gas supply inlet of the valve position controller.
